(19) United States
(12) Patent Application Publication
(10) Pub. No.: US 2026/0172749 A1
(43) Pub. Date: Jun. 18, 2026

(54) System For Filtering an Audio Signal

(71) Applicant: Bayerische Motoren Werke Aktiengesellschaft, Muenchen (DE)

(72) Inventor: Maximilian Wolf, Muenchen (DE)

(21) Appl. No.: 18/707,853

(22) PCT Filed: Oct. 12, 2022
(86) PCT No.: PCT/EP2022/078381

§ 371 Date: May 6, 2024

(30) Foreign Application Priority Data
Nov. 12, 2021 (DE) 10 2021 129 623.4

(51) Int. Cl. H04R 3/04

(52) U.S. Cl. CPC H04R 3/04; H04R 2430/01; H04R 2499/13

(57) ABSTRACT

A system filters an audio signal includes a signal input, a signal output, a scaling path, a limiter path, and a delay path. The signal input receives an input signal and the signal output for outputs an output signal. The limiter path is parallel to the scaling path. The delay path is between the signal input and the signal output parallel to the scaling path and the limiter path. The scaling path forms a scaling signal by forming a mean value of the input signal and using non-linear signal processing. The limiter path includes a low-pass characteristic and changes a phase of the input signal of the system in a manner dependent on frequency in order to generate a limiter signal. The system impresses the limiter signal that is scaled using the scaling signal onto a delay signal of the delay path in order to generate the output signal.

The present application is the U.S. national phase of PCT Application PCT/EP2022/078381 filed on Oct. 12, 2022, which claims priority of German patent application No. 10 2021 129 623.4 filed on Nov. 12, 2021, the disclosures of which are incorporated herein by reference in their entirety.

### TECHNICAL FIELD

Exemplary embodiments relate to a system for filtering an audio signal. In particular, the system is designed as a bass limiter, which advantageously can enable particularly few distortions when the filtered audio signal is rendered by means of loudspeakers. An audio system comprising such a limiter and at least one loudspeaker is also proposed, as is a vehicle comprising a corresponding audio system.

### BACKGROUND

In modern motor vehicles, audio systems for rendering information or else content from the field of entertainment are used as standard. The development of loudspeakers for rendering audio in the vehicle interior is driven, among other things, by a low space requirement and low costs for the individual chassis. However, loudspeakers with a small diaphragm and low back volume sometimes have disadvantages when producing sound, in particular of low-frequency signals (for example due to the radiation impedance of the loudspeaker diaphragm and built-in resonant frequency). The use of cost-optimized materials may not only reduce the audio quality but also result in a reduced loading capacity/power consumption of the loudspeaker chassis. At the same time, loudspeakers sometimes have to have a very high sound pressure level (for example >100 dB in 1 m), especially in the low-frequency range, in order to be able to effectively prevail against the driving noises at high speeds. The electrodynamic loudspeakers typically used in vehicles are therefore sometimes operated close to their mechanical and thermal power limits.

However, electrodynamic loudspeakers have linear transmission behavior only for small deflections. As the deflection increases, clearly non-linearities arise especially in the base range. The reasons for this can essentially be found in the profile of three characteristic variables of a loudspeaker: the force factor of the electrodynamic drive; the stiffness of the diaphragm suspension; and the inductance of the voice coil. The characteristic curves of these three variables progress linearly only in the case of very small deflections. When the voltage amplitude increases, the diaphragm deflection is compressed, which results in unwanted harmonic distortion products. In contrast, in higher frequency ranges, the deflection no longer poses a problem; in this case, the loudspeaker is instead endangered by overheating of the voice coil.

Particularly in the PA sector (public address systems) but also increasingly in the consumer sector, the voltage amplitude and thus the power consumption is limited in actively controlled loudspeaker systems. A limiter that is used as a signal filter therefore usually fulfils two functions: firstly, to prevent the loudspeaker from being destroyed by excessive mechanical loading or overheating. Secondly, audible distortions should be prevented. The limitation of level peaks (peak limiter) effectively performs the necessary task for the low-frequency range. However, the mode of operation of conventional limiters results in non-linear distortions due to the control process itself, said distortions being more pronounced, the more abruptly the signal amplitude is manipulated, that is to say limited. For thermal protection, a thermal limiter (root mean square/RMS limiter) is used to limit the level as required.

Document KR 101230004 B1 discloses a sound-active control system for a multiple-input loudspeaker. A preamplifier contains a sound input connection. The preamplifier amplifies the sound that is supplied via the sound input connection. Main amplifiers amplify the output signal of the preamplifier by virtue of them being connected to the preamplifier. A microcontroller controls the preamplifier. A relay unit is connected selectively to the main amplifiers and a microcontroller. A plurality of compression drivers are connected in parallel with the relay unit.

Document U.S. Pat. No. 3,480,835 discloses a thermal RMS (root mean square) limiter and a semiconductor circuit. However, it may be that the disclosed concepts no longer meet modern requirements.

### SUMMARY

The object of the present disclosure is to provide improved concepts for limiters in audio signal processing in order to enable at least fewer distortions in audio rendering or even to be able to prevent distortions completely.

This object is achieved according to the subject matter of the independent patent claims. Further advantageous embodiments are described in the dependent patent claims, the following description and in conjunction with the figures.

Accordingly, a system for filtering an audio signal is proposed. The system comprises at least one signal input for receiving an input signal and at least one signal output for outputting an output signal. These connections (for example input/output of an electronic circuit) are designed to receive electrical signals. In particular, audio signals are provided as the input and output signal.

The system also comprises a scaling path, a limiter path and a delay path. The signal input and the signal output are connected to one another by means of these three paths. In this case, the limiter path is formed parallel to the scaling path. The delay path is formed between the signal input and the signal output (for example directly between the signal input and the signal output) parallel to the scaling path and limiter path.

Provision is made for the scaling path to be designed to form a scaling signal by forming a mean value of the input signal and using non-linear signal processing. In the formation of a mean value, a root mean square (RMS) may be formed, for example. The non-linear signal processing may cause first signal components to be led through the scaling path from a particular signal level. For example, the scaling path may be designed in such a way that no scaling signal is output at the end of the scaling path in the case of low signal levels.

Provision is also made for the limiter path to have a low-pass characteristic and also be designed to change a phase of the input signal of the system in a manner dependent on frequency in order to generate a limiter signal. The limiter path is designed to provide the limiter signal with a changed phase at the end of the limiter path.

The system for filtering the audio signal is designed to impress the limiter signal that is scaled using the scaling signal onto a delay signal of the delay path in order to generate the output signal. To this end, for example, the scaling signal and the limiter signal are combined (for example by means of multiplication) in order to generate the scaled limiter signal. For example, provision may accordingly be made for the scaling signal to first be multiplied by the factor −1 and then for the scaled limiter signal to be added to the delay signal. As an alternative, the scaled limiter signal may also first be multiplied by the factor −1 and then added to the delay signal. As an alternative, the multiplication by the factor −1 the scaled limiter signal may also be subtracted from the delay signal.

As a result, by impressing the scaled limiter signal with a phase shift, low-frequency signal components can be damped or canceled such that it is possible to achieve damping of low frequencies in the output signal that is able to be fine-tuned and has reduced distortion or no distortion. The low-pass filtering and phase change carried out in the scaled limiter signal can enable selective cancelation of low-frequency signal components in the output signal compared to the input signal. As a result, when the output signal is rendered by means of a loudspeaker, it is possible to prevent overloading or overmodulation of the loudspeaker even at low frequencies. The proposed system may be described as a filter or limiter with a high-pass characteristic in order to filter out low-frequency signal components that may lead to overloading or non-linear deflection of a loudspeaker that is to be used.

According to one embodiment of the system, the scaling path may also have a low-pass characteristic. Provision may also be made for the non-linear signal processing to have a higher gain for frequencies with a higher amplitude than for frequencies with a low amplitude. As already mentioned, this may make it possible for the filter function to be used for low-frequency signal components only from a certain level (for example activation threshold), while low-frequency signal components with a low level that would not lead to overloading or overmodulation of the loudspeaker can pass through the system unfiltered.

In other words, the non-linear signal processing may be designed to output the scaling signal only from a predetermined minimum amplitude of the input signal. For low-frequency signals with a low amplitude or low level that do not lead to a significant deflection of a loudspeaker, it is in some circumstances not necessary to limit the signal since the loudspeaker in this case can output all frequencies without distortion.

According to one aspect of the disclosure, provision is made for a cut-off frequency of the low-pass characteristic of the scaling path and/or limiter path to be between 20 Hz (or 30 Hz or 50 Hz) and 500 Hz (or 30 Hz or 200 Hz or 100 Hz). In particular, the cut-off frequency of the low-pass characteristic of the scaling paths and/or limiter path may correspond to a specific resonant frequency of a loudspeaker at which the proposed system is intended to be operated.

For example, the limiter path is designed to produce a phase difference of 180° or uneven multiples of 180° (for example 540°) between frequencies above and below a cut-off frequency of the low-pass characteristic. This intended phase difference often cannot be achieved directly by real filters due to finite transition steepness of the filter curve; the phase difference may therefore be within certain tolerance values. The tolerance for the frequency spacing of a decade may be less than 10% (or less than 5%) and/or more than 3% (or more than 4%) in this case (for example a phase difference of more than 540°−50°=490° between signal components at a frequency of 200 Hz and a frequency of 2 kHz). For example, the tolerance of the phase difference for a frequency spacing of two decades may be less than 3% (or less than 2%) and/or more than 1%.

According to one aspect, provision may be made for the scaling path to also have a signal processing block for adjusting a compression of the scaling signal. For example, an attack and/or release of the scaling signal may be able to be adjusted as a result. The smoothing of the signal may cause further reduction in the generation of harmonics by the filter system itself, such that distortions generated by the filter itself, not on account of the filtered output signal, arise in the rendering of the output signal by means of a loudspeaker.

As already mentioned, the proposed system may be designed as a limiter for low frequencies. Accordingly, damping with respect to the input signal for low-frequency signal components below a cut-off frequency can be made possible in the output signal, wherein the degree of damping is greater at higher amplitudes than at low amplitudes.

Another aspect relates to an audio system comprising a system as described above or below and at least one loudspeaker. Provision is made for at least one cut-off value of the low-pass characteristic of the scaling path and/or limiter path to be adapted to a frequency response of the at least one loudspeaker. The individual adaptation of the cut-off frequency from which the delimiter function of the system is implemented can be used to operate the loudspeaker in an optimized fashion. In particular, low frequencies at a particular level that the loudspeaker can still render without distortion remain in the output signal of the system, such that a particularly good hearing experience can be ensured, for example. Furthermore, for example, the delay in the delay path of the system and/or the time window of the root mean square formation in the scaling path can also be adapted to the frequency range of the loudspeaker.

In particular, in the audio system, provision is made for a cut-off frequency of the low-pass characteristic of the scaling path and/or limiter path to correspond to a specific resonant frequency of the loudspeaker. In other words, the frequency range in which the loudspeaker has its greatest deflection can be restricted. Each loudspeaker chassis has a specific resonant frequency fₛ. For a frequency range <=fₛ, the diaphragm deflection on which harmonic distortions depend most is highest. This applies to each loudspeaker chassis, regardless of whether it is a subwoofer (overall transmission range approximately 20-150 Hz, at fₛ of for example 35 Hz), a mid-range chassis (at fₛ of for example 200 Hz) or a tweeter (at fₛ of example 2000 Hz). Adapting the cut-off frequency to the loudspeaker makes it possible to operate the audio system used particularly advantageously with respect to the balance between powerful rendering of low frequencies and prevention of harmonic distortions due to over manipulation of the loudspeaker.

Another aspect relates to a vehicle comprising an audio system as described above or below. The at least one loudspeaker is a mid-range speaker, for example. Subwoofers are often not used in vehicles for reasons of space; therefore, using the filter system to limit low frequencies for audio rendering by means of mid-range speakers present in the vehicle may be particularly advantageous for low-distortion audio rendering.

### BRIEF DESCRIPTION OF THE DRAWINGS

Exemplary embodiments are explained in more detail below with reference to the attached figures. In the figures:

FIG. 1 shows a schematic example of a system for filtering an audio signal;

FIG. 2 shows a schematic block diagram of an audio filter;

FIG. 3a shows an illustration of an exemplary filter function used in the system; and

FIG. 3b shows an illustration of a further exemplary filter function used in the system.

### DESCRIPTION

Various exemplary embodiments are now described in more detail with reference to the enclosed drawings, in which some exemplary embodiments are represented. In the figures, the thickness dimensions of lines, layers and/or regions may be exaggerated for the sake of clarity. In the following description of the attached figures, which show only a few exemplary embodiments, the same reference marks can refer to the same or comparable components.

An element that is referred to as “connected” or “coupled” to another element, may be directly connected or coupled to the other element, or there may be intervening elements. Unless otherwise defined, all terms used herein (including technical and scientific terms) shall have the same meaning as those given to them by an average person skilled in the field to which the exemplary embodiments belong.

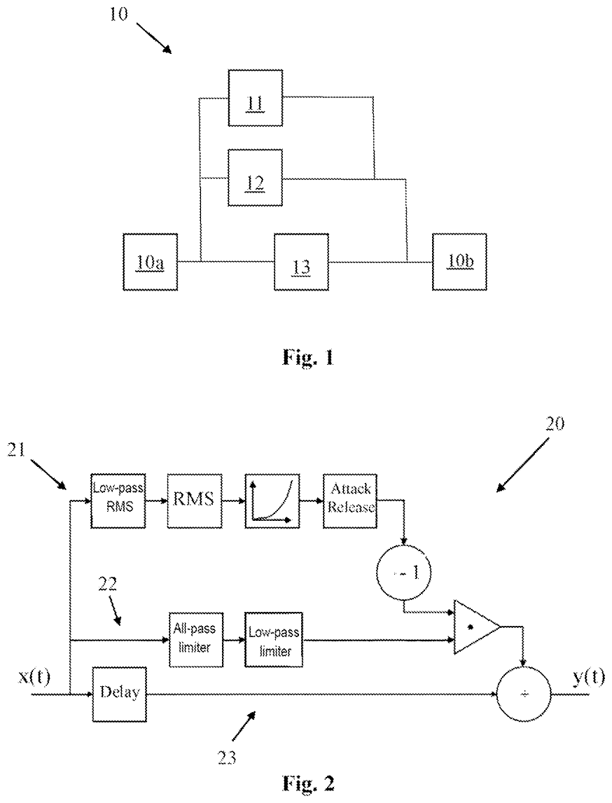

FIG. 1 shows a schematic example of a system 10 for filtering an audio signal. The system 10 comprises a signal input 10a and a signal output 10b. An input signal is led between the signal input 10a and the signal output 10b via signal paths arranged in parallel and is processed. In this case, a scaling path 11 is arranged parallel to a limiter path 12. A scaling signal is combined with a limiter signal at the end of the scaling path 11 and limiter path 12 and is combined with a delay signal at the output of a delay path 13. As a result, the filter system 10, for example an audio limiter, generates a processed signal that is output via the signal output 10b.

FIG. 2 shows a schematic block diagram of an audio filter 20 in more detail. The audio filter 20 shown by way of example illustrates an approach for limiting the diaphragm deflection. Like the system in FIG. 1, the audio filter has three signal paths. An input signal x(t) is first subject to low-pass filtering in a scaling path 21 before the RMS value is determined (signal processing blocks “Low-pass RMS” and “RMS”). The RMS values are mapped onto a value range of zero to one using a non-linear characteristic curve (schematically illustrated in the following signal processing block). This signal profile may subsequently be smoothed using an envelope detector with adjustable attack and release time (for example last signal processing block “Attack Release”). After this signal has been multiplied by −1, it is used as the scaling factor (for example the scaling signal).

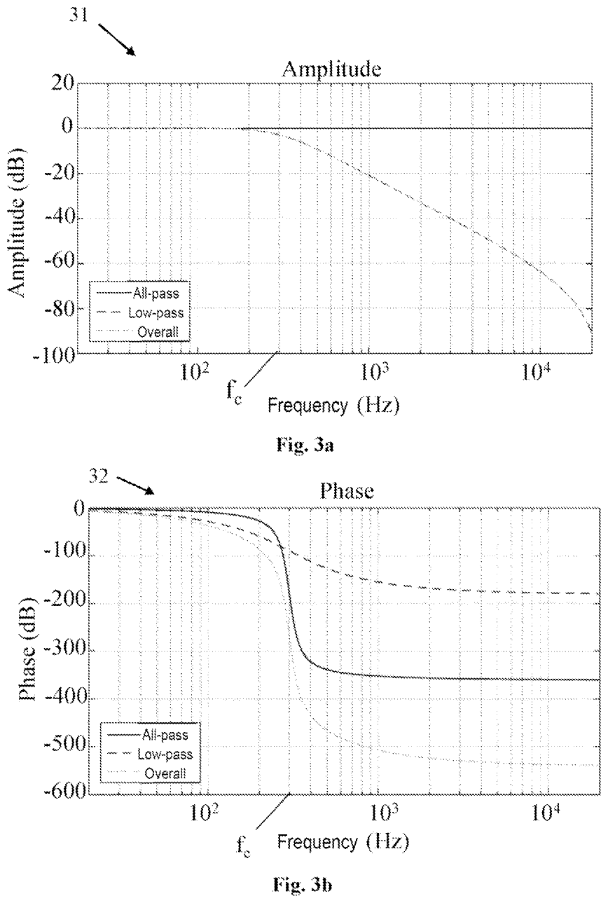

A limiter signal is calculated in a second signal path, a limiter path 22. One aspect on which the disclosure is based is changing the input signal x(t) in terms of the absolute value and phase profile thereof in a manner dependent on the frequency. The target profile of the phase is a phase difference of n×180° for n=1, 3, 5, etc. between the frequencies lower than a corner frequency f_{c} and frequencies greater than the corner frequency f_{c} (cut-off frequency; see also FIGS. 3a, 3b in this respect). Furthermore, the frequencies above f_{c} are intended to be damped in terms of their absolute value. This target function may be realized from a combination of an all-pass filter for example of the second order and a low-pass filter for example of the second order (signal processing block “All-pass limiter” and “Low-pass limiter”; see also FIGS. 3a, 3b).

A third signal path is a delay path 23 which causes a time delay in the input signal x(t) (signal processing block “Delay”). After the limiter signal has been standardized using the scaling factor, it is impressed on the delay signal in order to be output at the signal output as the output signal y(t).

Further details and aspects are mentioned in connection with the exemplary embodiments described above or below.

The exemplary embodiment shown in FIG. 2 may have one or more optional additional features that correspond to one more aspects that are mentioned in connection with the proposed concept or with one or more exemplary embodiments that are described above (for example FIG. 1) or below (for example FIGS. 3-5).

FIGS. 3a, 3b each show a schematic illustration of a filter function of an all-pass filter and low-pass filter used in the system 10 or audio system 20. FIGS. 3a, 3b show the absolute value spectrum 31 and the phase profile 32 of both individual filter elements and both filter elements together. The filter curves of all-pass, low-pass and the combination overall are illustrated by the different types of shading.

The phase profile at low frequencies below a cut-off frequency f_{c}, in this case for example 300 Hz, approximates 0°; at f_{c} the phase is 180° and above f_{c} the phase profile approximates 540°. The absolute value profile is identical to the absolute value profile of the low-pass filter. Using the sampled multiplication of the limiter signal (processed by means of the all-pass and low-pass) by the scaling signal, a further phase offset by 180° is impressed and is scaled depending on the amplitude thereof.

This scaled and phase-rotated limiter signal is added to the delayed input signal (at the end of the delay path 13, 23) and the signal amplitude in the output signal y(t) is canceled or damped in a manner dependent on frequency. The degree of damping is dependent on the RMS value of the input signal x(t) and can be fine-tuned via the non-linear characteristic curve in the scaling path 11, 21; the higher the RMS value, the higher the degree of damping. Due to the gentle profile of the phase and the absolute value of the limiter signal or the filter for generating the limiter signal, the cancelation or limitation of the input signal runs very homogeneously and without distortion.

Aspects of the disclosure relates to a base limiter without distortion. The proposed system may produce an output signal that prevents or reduces over manipulation of a loudspeaker during rendering and in which particularly few harmonic distortions compared to the input signal are added due to the filter function itself. The proposed limiter can be implemented with appropriate dimensioning in all areas of audio processing, for example public address systems, home audio or in vehicles.

1-11. (canceled)

12. A system for filtering an audio signal, the system comprising:
a signal input for receiving an input signal and a signal output for outputting an output signal;
a scaling path;
a limiter path, which is disposed parallel to the scaling path; and
a delay path, which is disposed between the signal input and the signal output parallel to the scaling path and the limiter path,
wherein the scaling path is configured to form a scaling signal by forming a mean value of the input signal and using non-linear signal processing,
wherein the limiter path includes a low-pass characteristic and is configured to change a phase of the input signal of the system in a manner dependent on frequency in order to generate a limiter signal, and
wherein the system is configured to impress the limiter signal that is scaled using the scaling signal onto a delay signal of the delay path in order to generate the output signal.

13. The system as claimed in claim 12, wherein the scaling path has a low-pass characteristic.

14. The system as claimed in claim 13, wherein the non-linear signal processing has a higher gain for frequencies with a higher amplitude than for frequencies with a low amplitude.

15. The system as claimed in claim 14, wherein the non-linear signal processing is designed to output the scaling signal only from a predetermined minimum amplitude of the input signal.

16. The system as claimed in claim 15, wherein a cut-off frequency of the low-pass characteristic of the scaling path is between 20 Hz and 500 Hz.

17. The system as claimed in claim 16, wherein a cut-off frequency of the low-pass characteristic of the limiter path is between 20 Hz and 500 Hz.

18. The system as claimed in claim 12, wherein a cut-off frequency of the low-pass characteristic of the limiter path is between 20 Hz and 500 Hz.

19. The system as claimed in claim 12, wherein the limiter path is designed to produce a phase difference of 180° or uneven multiples of 180° between frequencies above and below a cut-off frequency of the low-pass characteristic.

20. The system as claimed in claim 12, wherein the scaling path further includes a signal processing block for adjusting a compression of the scaling signal.

21. The system as claimed in claim 12, wherein the system is configured to produce damping with respect to the input signal for low-frequency signal components in the output signal, wherein the degree of damping is greater at higher amplitudes than at low amplitudes.

22. The system as claimed in claim 21, wherein the non-linear signal processing has a higher gain for frequencies with a higher amplitude than for frequencies with a low amplitude.

23. The system as claimed in claim 22, wherein the non-linear signal processing is designed to output the scaling signal only from a predetermined minimum amplitude of the input signal.

24. The system as claimed in claim 21, wherein the limiter path is designed to produce a phase difference of 180° or uneven multiples of 180° between frequencies above and below a cut-off frequency of the low-pass characteristic.

25. An audio system, comprising:
a system as claimed in claim 12; and
at least one loudspeaker,
wherein at least one cut-off frequency of at least one of the group consisting of the low-pass characteristic of the limiter path and a low-pass characteristic of the scaling path is adapted to a frequency response of the at least one loudspeaker.

26. The audio system as claimed in claim 25, wherein a cut-off frequency of the low-pass characteristic of the limiter path corresponds to a specific resonant frequency of the loudspeaker.

27. The audio system as claimed in claim 26, wherein a cut-off frequency of the low-pass characteristic of the scaling path corresponds to a specific resonant frequency of the loudspeaker.

28. The audio system as claimed in claim 25, wherein a cut-off frequency of the low-pass characteristic of the scaling path corresponds to a specific resonant frequency of the loudspeaker.

29. A vehicle comprising an audio system as claimed in claim 25, wherein the at least one loudspeaker is a mid-range speaker.
